(19) United States
(12) Patent Application Publication
(10) Pub. No.: US 2025/0355669 A1
(43) Pub. Date: Nov. 20, 2025

(54) DIFFERENTIAL TREATMENT OF CONTEXT-SENSITIVE INDIRECT BRANCHES IN INDIRECT TARGET PREDICTORS

(71) Applicant: HUAWEI TECHNOLOGIES CO., LTD., SHENZHEN (CN)

(72) Inventors: Henry Fangli KAO, Kanata (CA); Nikhil SREEKUMAR, Kanata (CA); Maziar GOUDARZI, Kanata (CA); Reza AZIMI, Kanata (CA); Ali SEDAGHATI, Kanata (CA)

(73) Assignee: HUAWEI TECHNOLOGIES CO., LTD., SHENZHEN (CN)

(21) Appl. No.: 18/665,725

(22) Filed: May 16, 2024

(51) Int. Cl. G06F 9/30

(52) U.S. Cl. CPC G06F 9/323; G06F 8/433; G06F 8/443

(57) ABSTRACT

Methods and apparatus are provided to improve target prediction for indirect branches of computer programs. To improve the efficiency of indirect target predictors (JTPs), embodiments of the present disclosure partition JTPs to separately handle context-sensitive and context-insensitive indirect branches. Indirect branches are transformed with indicators of their context sensitivity to enable correct handling by a partitioned JTP. Embodiments use a program optimizer to analyze control flows within computer programs to determine the context sensitivity of indirect branches. In some embodiments, context sensitivity is established from data-flow graphs. In other embodiments, context sensitivity is established from profiling data of the computer program.

### CROSS-REFERENCE TO RELATED APPLICATIONS

This is the first application filed for the present invention.

### FIELD OF THE INVENTION

The present invention pertains to computer program execution and in particular to methods and apparatus for branch prediction.

### BACKGROUND

Modern architectures for computer processing units (CPUs) have branch predictors that predict branch and call targets before a given branch or call instruction executes. The branch predictors enable the CPU to speculatively execute forthcoming instructions without waiting for a target to be computed. CPU throughput, and hence performance, can be improved by correct predictions. However, incorrect predictions can cause the CPU to flush instructions and repeat execution starting from the offending instruction, which can incur latency. A CPU can contain many different branch predictor structures, each specialized for different tasks.

Branch predictors can store encodings of the program counter for a branch or call and its target. The hardware structures of branch predictors are often limited by size and so may only accurately track a subset of branches and calls. In large programs with complex control flows, it can be hard for these branch predictor structures to accurately predict the behavior of branches and calls. Furthermore, branch predictors can be implemented with varying levels of complexity. Whereas simpler hardware can be accessed faster and hence redirect a fetch program counter (PC) with lower latency, more complicated branch predictors have higher accesses latency and may take more cycles to redirect a fetch PC to the predicted target. Given the size limitation of the branch predictors and their access latency, efficiently allocating branch predictor space to the most troublesome branches and calls, and properly selecting the complexity of the branch predictor can be important.

Indirect branch and call targets are particularly difficult to predict correctly, because an infinite number of targets can be possible, and the targets can change at runtime. An indirect target predictor (ITP) can be used to predict targets of indirect branches and calls. However, ITPs typically consider all indirect branches and calls as context-sensitive (CS), wherein the probability of an indirect branch or call taking a certain target is affected by the control flow path taken to arrive there. Consequently, ITPs track context information in a form of prior history. Indirect branches and calls that are context-insensitive (CIS) do not benefit from the context information during branch prediction. Thus, CIS indirect branches and calls can needlessly occupy scarce space in the ITP that could be better used towards CS indirect branches and calls.

Therefore, there is a need for a method and apparatus for target prediction of indirect branches and calls that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and apparatus for target prediction of indirect branches and calls.

A first aspect the present disclosure is to provide a method to be performed at an electronic device including a first processing unit and a second processing unit each coupled to tangible, non-transitory processor-readable memory. The method may comprise receiving, from a computer program, an instruction representing an indirect branch of the computer program. The instruction may have an indicator identifying one of context-sensitive (CS) and context-insensitive (CIS). The method may further comprise providing, when at least one of a respective directory at each of the first processing unit and the second processing unit has a respective existing entry corresponding to the instruction, a target identifier of at least one respective existing entry. The target identifier may identify a target for the indirect branch. The method may still further comprise generating, in the respective directory at the first processing unit when the instruction indicates CIS and in the respective directory at the second processing unit when the instruction indicates CS, a respective instant entry corresponding to the instruction when the respective directories at each of the first processing unit and the second processing unit do not have the respective existing entry corresponding to the instruction.

In some embodiments of the first aspect, the method may further comprise determining, at the first processing unit when the instruction indicates CIS and at the second processing unit when the instruction indicates CIS, whether the respective directory has the respective existing entry corresponding to the instruction.

In some embodiments of the first aspect, the respective existing entry of the respective directory at the first processing unit may be a tag including a hash of a program counter. In some embodiments, the respective existing entry of the respective directory at the second processing unit is a tag including a hash of a program counter and context information. In some of these embodiments, the context information may include at least one of a branch address, a branch taken and not-taken history, and a function call stack. In some embodiments, the indicator of the instruction may be a label of one of CS and CIS.

In some embodiments of the first aspect, generating, in the respective directory at the first processing unit when the instruction indicates CIS and in the respective directory at the second processing unit when the instruction indicates CS, the respective instant entry corresponding to the instruction when the respective directories at each of the first processing unit and the second processing unit does not have the respective existing entry corresponding to the instruction may include initiating a fill mechanism to complete the respective instant entry in accordance with the target for the indirect branch of the computer program. In some embodiments, providing, when at least one of the respective directories at each of the first processing unit and the second processing unit has the respective existing entry corresponding to the instruction, the target identifier of at least one respective existing entry may include providing, when each of the respective directories at each of the first processing unit and the second processing unit has the respective existing entry corresponding to the instruction, the target identifier of one respective existing entry in accordance with an arbitration scheme.

A second aspect of the present disclosure is to provide an electronic device comprising a first processing unit and a second processing unit each coupled to non-transitory processor-readable memory, with the memory having stored thereon instructions to be executed by the first processing unit and the second processing unit to implement the method of the first aspect.

A third aspect of the present disclosure is to provide a method to be performed at a processing unit coupled to tangible, non-transitory processor-readable memory. The method may comprise receiving a sequence of instructions defining a first computer program. One or more instructions of the sequence of instructions may each represent a respective indirect branch of the first computer program. Each indirect branch may have associated thereto a respective target. The method may further comprise executing, for each of the one or more instructions of the sequence of instructions, a set of actions. The set of actions may include: generating a respective data-flow representation identifying one or more respective preceding instructions of the sequence of instructions, wherein each of the preceding instructions, when executed, determines the respective target of the respective indirect branch; and transforming, when more than one respective preceding instruction, when executed, determines the respective target of the respective indirect branch, the respective instruction to have an indicator identifying CS. The method may still further comprise providing a second computer program depending from the first computer program and including each of the transformed instructions.

In some embodiments of the third aspect, the set of actions may further include transforming, when the respective target of the respective indirect branch is independent from the one or more respective preceding instructions, the respective instruction to have an indicator identifying CIS. In some embodiments, the set of actions may further include analyzing the respective data-flow representation to determine whether more than one preceding instruction, when executed, determines the respective target of the respective indirect branch.

In some embodiments of the third aspect, the method may further comprise evaluating each instruction of the sequence of instructions to determine whether the respective instruction generates values, for one or more subsequent instructions of the sequence of instructions, in the data-flow representation.

In some embodiments of the third aspect, the data-flow representation respective to each of the one or more instructions may be a data-flow graph defining respective dependencies of the respective target on the one or more respective preceding instructions.

A fourth aspect of the present disclosure is to provide another method to be performed at a processing unit coupled to tangible, non-transitory processor-readable memory. The method may comprise receiving a sequence of instructions defining a first computer program, one or more instructions of the sequence of instructions each representing a respective indirect branch of the first computer program. Each indirect branch may have associated thereto a respective one or more targets. The method may further comprise receiving profile data corresponding to at least one execution of the first computer program; evaluating the first computer program in accordance with the profile data to identify the one or more instructions of the sequence of instructions; transforming, for each of the one or more instructions of the sequence of instructions, when the respective indirect branch has more than one respective target and when at least one respective target is CS, the respective instruction to have an indicator identifying CS; and providing a second computer program depending from the first computer program and including each of the transformed instructions.

In some embodiments of the fourth aspect, the method may further comprise transforming, for each of the one or more instructions of the sequence of instructions, when the respective indirect branch has fewer than two respective targets, the respective instruction to have an indicator identifying CIS. In some embodiments, the method may further comprise transforming, for each of the one or more instructions of the sequence of instructions, when the one or more respective targets of the respective indirect branch are context-insensitive, the respective instruction to have an indicator identifying CIS. In some embodiments, the method may further comprise evaluating the first computer program in accordance with the profile data to determine, for each of the one or more instructions of the sequence of instructions, whether the respective indirect branch has more than one respective target. In some other embodiments, the method may further comprise evaluating the first computer program in accordance with the profile data to determine, for each of the one or more instructions of the sequence of instructions, whether at least one respective target is CS.

In some embodiments of the fourth aspect, the profile data may be a combination of a plurality of profiles each associated with a respective execution of the first computer program.

Embodiments of the present disclosure may facilitate a classification of indirect branches in computer programs as CS or CIS such that they may be handled by respective processing units. Embodiments of the present disclosure may improve accuracy and reduce latency in the prediction of targets for indirect branches.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows an example schematic for a front-end of a computer processing unit.

FIG. 2 shows an example diagram of a process pipeline for branch prediction.

FIG. 3A shows an example control flow path with a context-sensitive indirect branch.

FIG. 3B shows an example control flow path with a context-insensitive indirect branch.

FIG. 4 shows examples of indirect branch and call instructions.

FIG. 5 shows a system architecture for target prediction in accordance with embodiments of the present disclosure.

FIG. 6 shows examples of indirect branch and call instructions in accordance with embodiments of the present disclosure.

FIG. 7 shows a schematic for an indirect target predictor in accordance with an embodiment of the present disclosure.

FIG. 8 shows a flowchart for a method for indirect target prediction in accordance with an embodiment of the present disclosure.

FIG. 9 shows a flowchart for a method for optimizing computer programs to indicate context sensitivity in accordance with an embodiment of the present disclosure.

FIG. 10 shows a flowchart for another method for optimizing computer programs to indicate context sensitivity in accordance with an embodiment of the present disclosure.

FIG. 11 shows a schematic of an apparatus for indirect target prediction according to embodiments of the present disclosure.

FIG. 12 shows a schematic of an embodiment of an electronic device that may implement at least part of the methods and features of the present disclosure.

It will be noted that throughout the appended drawings, like features are identified by like reference numerals.

### DETAILED DESCRIPTION

To improve target prediction for indirect branches and calls of computer programs, embodiments of the present disclosure are generally directed towards identifying context-sensitive (CS) and context-insensitive (CIS) indirect branches and calls, and processing them by respective target predictors. In some embodiments, a program optimizer may use static analysis or profiling information to classify indirect branches and calls as CS or CIS. Each indirect branch or call may be labelled to identify it, accordingly, as CS or CIS. In some embodiments, an indirect target predictor (ITP) may be partitioned into a CS-ITP and a CIS-ITP, such that indirect branches and calls are directed to the corresponding partition of the ITP for target prediction. Target prediction for CS indirect branches and calls may use context information whereas that for CIS branches and calls may not. This segregation of CS and CIS indirect branches and calls may enable more efficient use of space at an ITP.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. The terms “branches” and “call and branch instructions” may be used interchangeably throughout the disclosure.

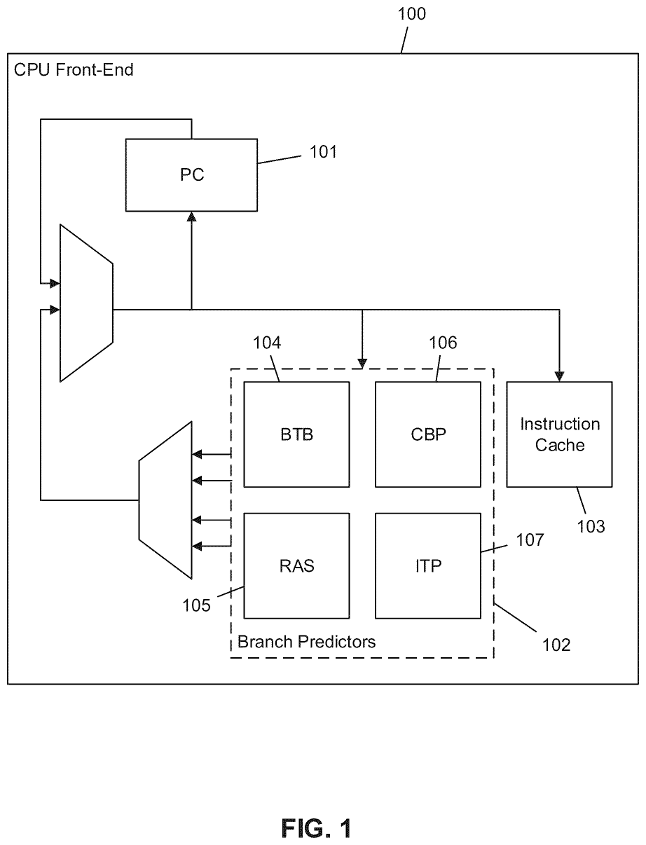

FIG. 1 shows a schematic for a front-end 100 of a computer processing unit (CPU). The CPU front-end 100 is configured to fetch instructions from a computer program and provide branch prediction. The CPU front-end 100 comprises a program counter (PC) 101, a plurality of branch predictors 102, and an instruction cache 103. Instructions are fetched sequentially, such as from the instruction cache 103, by incrementing the PC 101. Branch instructions and call instructions may redirect the fetching of instructions by rewriting the PC 101 to correspond to the target of the branch instruction or call instruction (i.e., the branch or call target). In the present disclosure, the term branches may be used to collectively refer to branch instructions and call instructions. Branch predictors 102 may store encodings of the branches and their targets to predict likely targets. The branch predictors 102 may be used to redirect instruction fetching by the PC 101 with lower latency. The CPU front-end 100 can comprise different branch predictor structures specialized for different tasks. In FIG. 1 the plurality of branch predictors 102 includes: a branch target buffer (BTB) 104, which stores almost all frequent branches and their targets; a return address stack (RAS) 105, which stores return addresses for function return instructions; a conditional branch predictor (CBP) 106, which predicts outcomes for conditional branches; and an ITP 107, which predicts targets for indirect branches. Branch predictors 102 may be limited by the size and complexity of their hardware structures, the scope of branches that they may accurately track, and the complexity of control flows in the computer program.

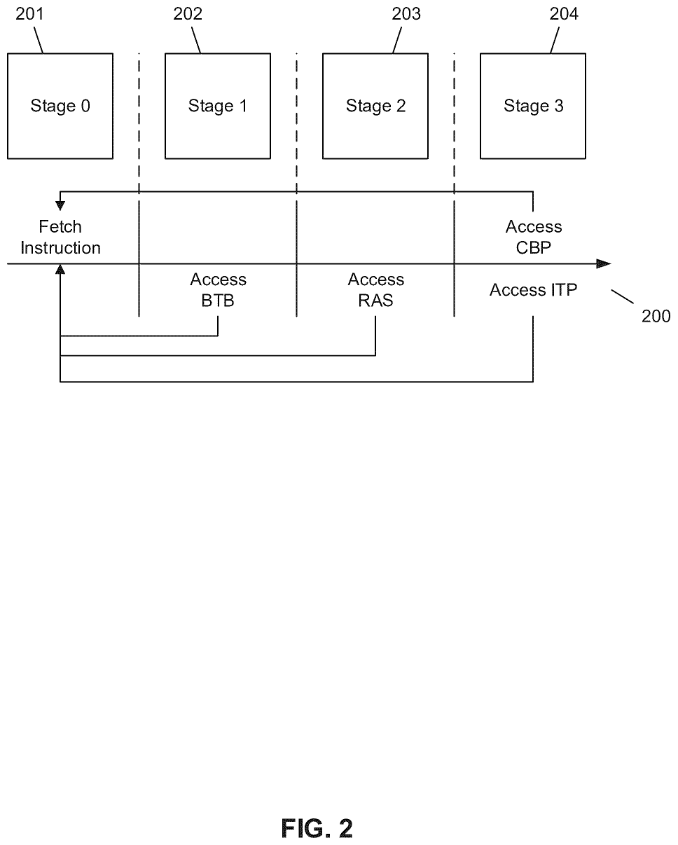

FIG. 2 shows a schematic for a diagram of a process pipeline 200 for a CPU front-end 100. The process pipeline 200 comprises a first stage (stage 0) 201, a second stage (stage 1) 202, a third stage (stage 2) 203, and a fourth stage (stage 3) 204. Examples of accesses of branch predictors 102 at different stages of the process pipeline 200 are shown in FIG. 2. At the first stage 201 an instruction is fetched. Then at the second stage 202, third stage 203, and fourth stage 204, a BTB 104, a RAS 105, a CBP 106, and an ITP 107 are consecutively accessed and may redirect the fetching of instructions at the first stage 201. Branch predictors 102 with more complex hardware structures, in comparison to simpler branch predictors 102, may track branch history and so have higher access latency and may require more cycles to redirect fetching to the correct target. Thus, simpler branch predictors, such as the BTB 104, may be accessed at earlier stages, whereas, complex branch predictors, such as the CBP 106 and ITP 107, may be accessed at later stages to minimize latency in fetching instructions.

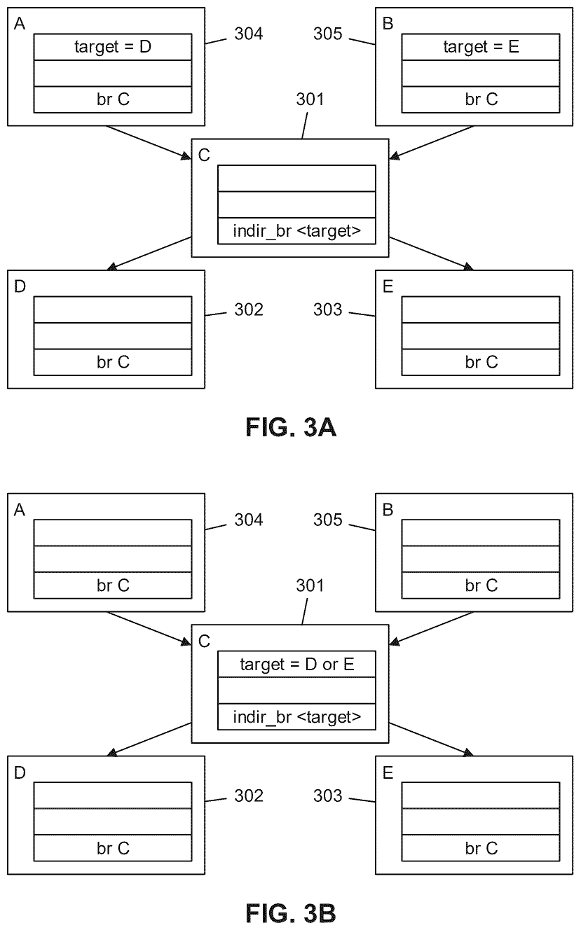

FIG. 3A shows an example of a control flow with code blocks that have an indirect branch. Branch predictions for indirect branches are particularly difficult. Here, the branch target is not statically known but is rather computed at runtime. Because indirect branches can have infinite possibilities for targets, obtaining correct predictions by an ITP 107 can be challenging. However, indirect branches may be CS, wherein the probability of the indirect branch having a particular target depends on the control flow path taken to arrive at the branch. In FIG. 3A, code block C 301 includes an indirect branch “indir_br” where the target is not statically known and may direct to either code block D 302 or code block E 303. In this case, the indirect branch is CS because code block A 304 and code block B 305, from which arrival at code block C 301 is possible, each define a respective target address. If code block C 301 is reached from code block A 304, then the target can be accurately predicted to be code block D 302. If, however, code block C 301 is reached from code block B 305, then the target can be accurately predicted to be code block E03.

FIG. 3B shows another example of a control flow with code blocks that have an indirect branch. Unlike the example of FIG. 3A, the example of FIG. 3B includes an indirect branch that is CIS, wherein the probability of the indirect branch having a particular target does not depend on the context in which the indirect branch was reached. In the case of FIG. 3B, neither code block A 304 nor code block B 305 define a target address, and therefore, the indirect branch of code block C 301 does not depend on the context of arrival. In other words, code block C 301 could direct to either code block D 302 or code block E 303 regardless of whether code block C 301 was reached from code block A 304 or code block B 305. For CIS indirect branches, context information does not improve the prediction of targets. In some cases, a CS indirect branch may similarly not benefit from context information if the information needed to make an accurate prediction is too complicated to determine statically or dynamically (i.e., at runtime).

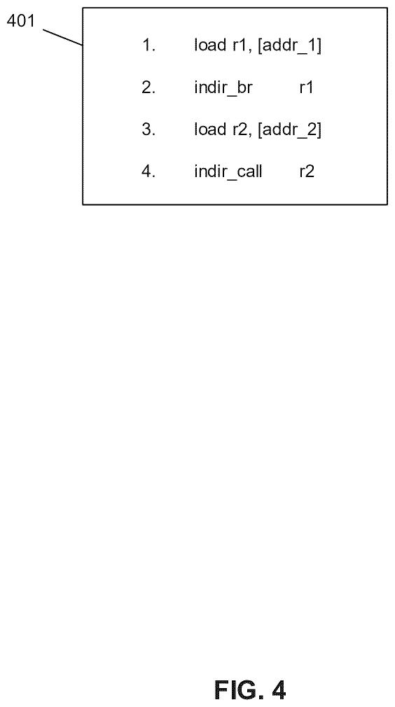

FIG. 4 shows an example of indirect branch and call instructions in a sample of assembly-language pseudocode 401 of a computer program. At line 1, the address “addr_1” is loaded to register “r1”. At line 2, there is an indirect branch instruction “indir_br” that redirects the computer program to the address stored in register “r1”. Then, at line 3, the address “addr_2” is loaded to register “r2”. At line 4, there is an indirect call instruction “indir_call” that redirects the computer program to the address stored in register “r2”. In this example, each indirect branch is handled as a CS branch regardless of whether that branch is CS or CIS. By assuming that each indirect branch requires context information, such as a control flow history, the limited capacity of an ITP 107 may be wasted in storing context information for CIS indirect branches.

Embodiments of the present disclosure may improve target prediction accuracy and latency for indirect branches by allocating CS and CIS indirect branches to different predictor hardware. In this way, CIS indirect branches, which do not benefit from context information, may be allocated to hardware with lower access latency and ITP capacity that tracks context information may be reserved for CS indirect branches. In some embodiments, indirect branches, such as those described in relation to FIG. 4, may be labeled as CS or CIS by an instruction set architecture (ISA) of the CPU. In some embodiments, a code optimizer, such as a compiler or binary optimization tool, may transform indirect branches to a CS or CIS form in accordance with a static analysis or profiling information. In embodiments of the present disclosure, indirect branches may include indirect branch instructions and indirect call instructions as well as function return instructions, which may have multiple target possibilities and may behave similarly to indirect branch instructions.

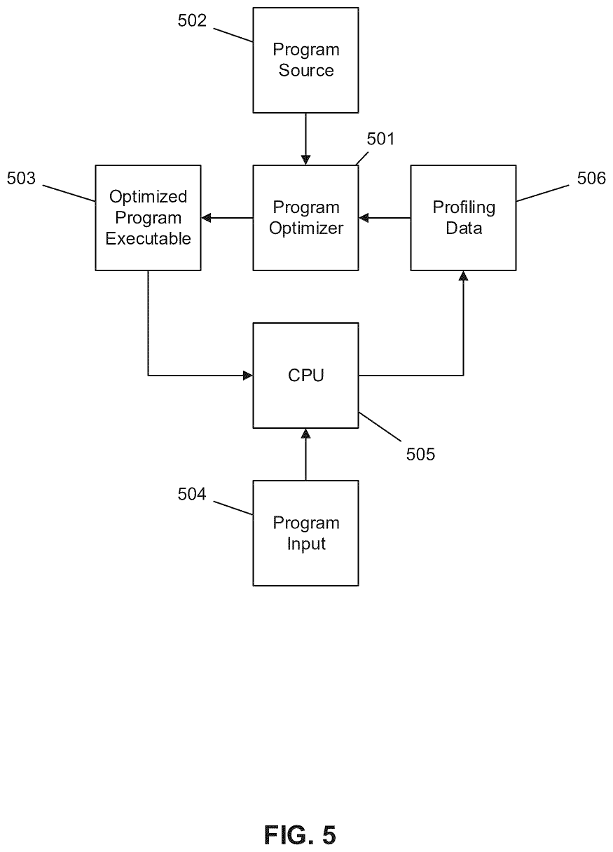

FIG. 5 shows a schematic of a system architecture of indirect branch prediction in accordance with embodiments of the present disclosure. A program optimizer 501 receives a program (i.e., a first computer program) from a program source 502. The program may, for example, be a program source code, a program binary, or an intermediate form thereof. The program optimizer 501 may, for example, be a compiler or a binary optimizer. The program optimizer 501 may be configured to generate an optimized program executable 503 (i.e., a second computer program) that includes indirect branches each labelled as either CS or CIS. The optimized program executable 503, along with program input 504, may be executed by computing hardware, such as an ITP, that is implemented in a CPU 505 or other processing unit. In some embodiments, the execution of the program may be profiled to generate one or more sets of profiling data 506, which may be used towards input 504 for the program optimizer 501 for generating a more optimized program executable 503.

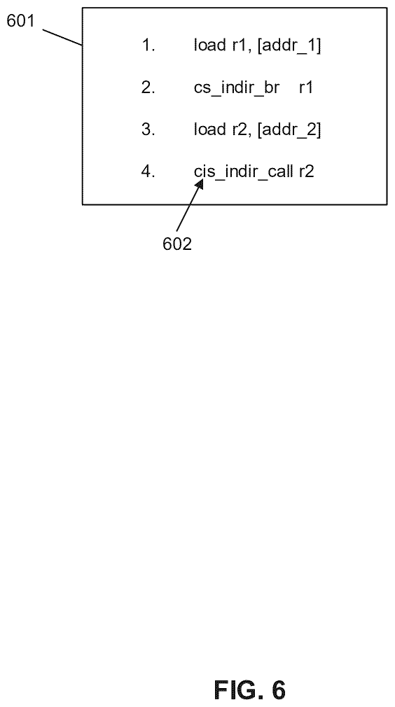

FIG. 6 shows an example of an indirect branch instruction and an indirect call instruction in a sample of assembly-language pseudocode 601 in accordance with an embodiment of the present disclosure. Instructions at lines 1 to 4 are similar to those described in relation to FIG. 4; however, each of the indirect branches at lines 2 and 4 have an indicator comprising a context-sensitivity label 602 that identifies the indirect branch as either CS or CIS. At line 2, the indirect branch instruction has been transformed to a CS form “cs_indir_br”, and at line 4, the indirect call instruction has been transformed to a CIS form “cis_indir_br”. In some other embodiments, CS and CIS may be indicated by different labels. In some embodiments, the presence or absence of a label on an indirect branch may be used as an indicator to identify the branch as either CS or CIS, rather than alternative labels for CS and CIS. In some embodiments, CS indirect branches may have a CIS indicator when the associated context information is overly complicated.

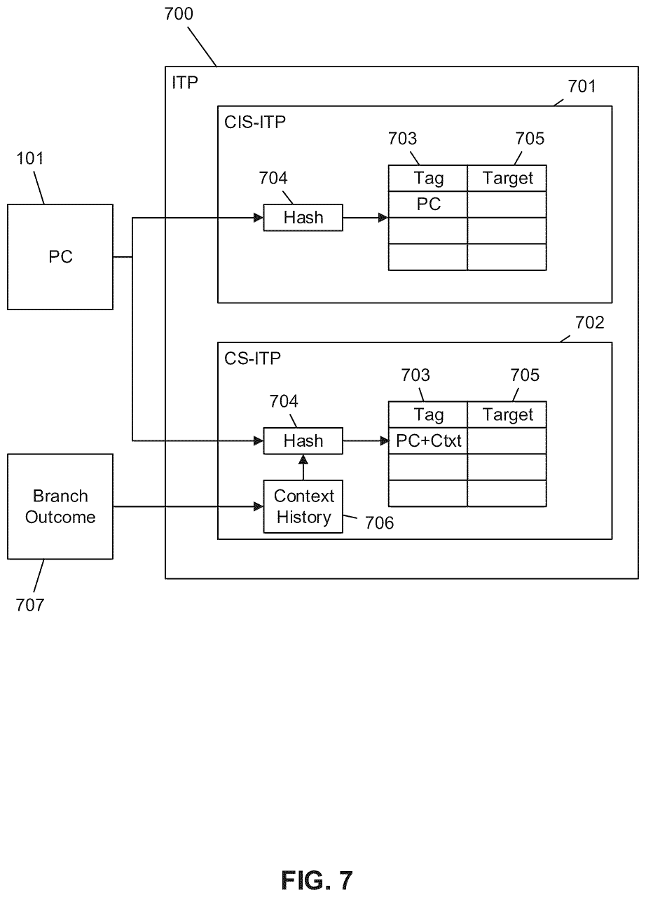

FIG. 7 shows a schematic of an ITP 700 in accordance with an embodiment of the present disclosure. The ITP 700 may form part of a CPU 505 for execution of an optimized program executable 503, as described in relation to FIG. 5. The ITP 700 may comprise a CIS-ITP 701 (i.e., a “first processing unit”) and a CS-ITP 702 (i.e., a “second processing unit”), which may be configured to provide target predictions for CIS and CIS indirect branches, respectively.

The CIS-ITP 701 may have a directory, or index, with entries of likely targets for indirect branches with a CIS indicator. Each entry may be associated with a respective CIS indirect branch by a tag 703, which may, for example, be a hash 704 of a PC 101. In the directory, each tag 703 may then map to a respective target identifier 705, which may, for example, be a target address or target PC. When the CIS-ITP 701 is accessed to make a target prediction for a CIS indirect branch, the directory may be inspected for a corresponding tag 703. If the corresponding tag 703 is successfully found (i.e., a hit is returned), the target identifier 705 associated with the tag 703 may be provided to redirect instruction fetching to the appropriate target address.

The CS-ITP 702 may have a directory, or index, with entries of likely targets for indirect branches with a CS indicator. Each entry may be associated with a respective CS indirect branch by a tag 703, which may, for example, be a PC 101 hashed 704 together with context information 706. Context information 706 may be information on the control-flow path taken to reach the indirect branch. The context information 706 may include, for example, branch addresses, a history of branches taken and/or not taken, and a function call stack. The context information 706 may be obtained from branch outcomes 707 from one or more executions of the computer program. In the directory, each tag 703 may then map to a respective target identifier 705, which may, for example, be a target address. When the CS-ITP 702 is accessed to make a target prediction for a CS indirect branch, the directory may be inspected for a corresponding tag 703. If a hit is returned, the target identifier 705 associated with the tag 703 may be provided to redirect instruction fetching to the appropriate target address.

When implementing the ITP 700 of FIG. 7 in a process pipeline 200, the CIS-ITP 701 may be preferably accessed in an earlier stage than the CS-ITP 702. Because the CIS-ITP 701 does not involve an inspection of context information, it may have lower access latency than the CS-ITP 702 and may provide faster target predictions. In contrast, the inspection of context information at the CS-ITP 702 may enable more accurate predictions for branches indicated as CS.

In some embodiments of the present disclosure, when an indirect branch lacks both a CS and a CIS indicator, either the CIS-ITP 701 or the CS-ITP 702, or both, may be accessed. When a hit is returned for both the CIS-ITP 701 and the CS-ITP 702, an arbitration scheme may be used to select one target address from among those provided by the CIS-ITP 701 and the CS-ITP 702. A person of skill in the art will appreciate that a variety of methods may be suitable for the arbitration scheme, which may include but may not be limited to choosing the target address of the first of the CIS-ITP 701 and the CS-ITP 702 to return a target address, or implementing a tournament-style scheme where the accuracy of branch target addresses for the CIS-ITP 701 and the CS-ITP 702 are tracked dynamically, and the one providing the most accurate results is chosen. In some embodiments, the CPU 505 may dynamically allocate CIS indirect branches to the CS-ITP 702 when, for example, the CIS-ITP 701 is fully occupied. Similarly, the CPUS 505 may dynamically allocate CS indirect branches to the CIS-ITP 701 when, for example, the CS-ITP 702 is fully occupied.

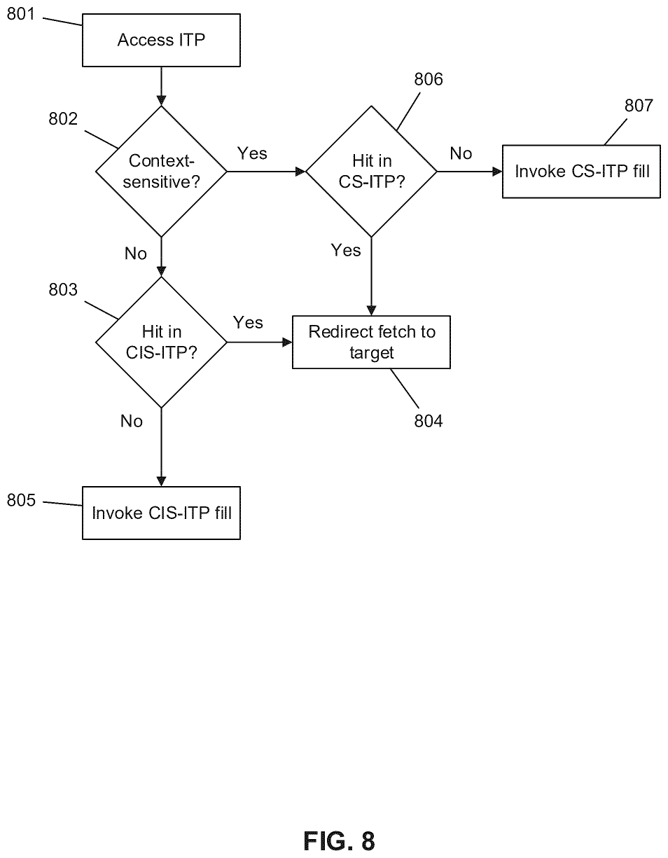

FIG. 8 shows a flowchart for a method of target prediction in accordance with an embodiment of the present disclosure. The method may be implemented, at least in part, by the ITP 700 described in relation to FIG. 7. At action 801, the ITP 700 may be accessed with a branch address for an indirect branch. At action 802, the indirect branch may be evaluated to determine whether the indirect branch is identified as CS or CIS. This may include evaluating an indicator such as a label of the indirect branch or evaluating the context sensitivity of the indirect branch. When the indirect branch is indicated as being CS, the CS-ITP 702 of the ITP 700 may be then accessed, and when the indirect branch is indicated as being CIS, the CIS-ITP 701 of the ITP 700 may be then accessed. At action 803, when the indirect branch is indicated as being CIS, the directory at the CIS-ITP 701 may be inspected to determine whether an entry corresponding to the indirect branch exists in the directory (i.e., the directory may be inspected for a hit). This may include matching the indirect branch to the tag of an entry. When a hit occurs, at action 804, the target identifier may be provided to redirect instruction fetching to the associated target. When a hit does not occur, at action 805, an entry may be generated for the indirect branch in the directory of the CIS-ITP 701. This may include initiating a fill mechanism to allocate space for the entry and to complete it. A person of skill in the art will appreciate that a variety of methods may be suitable for the fill mechanism, which may include but not be limited to random replacement or Least Recently Used (LRU) replacement. At action 806, when the indirect branch is indicated as being CS, the directory at the CS-ITP 702 may be inspected to determine whether an entry corresponding to the indirect branch exists in the directory (i.e., the directory may be inspected for a hit). This may include matching the indirect branch to the tag of an entry. When a hit occurs, at action 804, the target identifier may be provided to redirect instruction fetching to the associated target. When a hit does not occur, at action 807, an entry may be generated for the indirect branch in the directory of the CS-ITP 702. This may include initiating a fill mechanism to allocate space for the entry and to complete it.

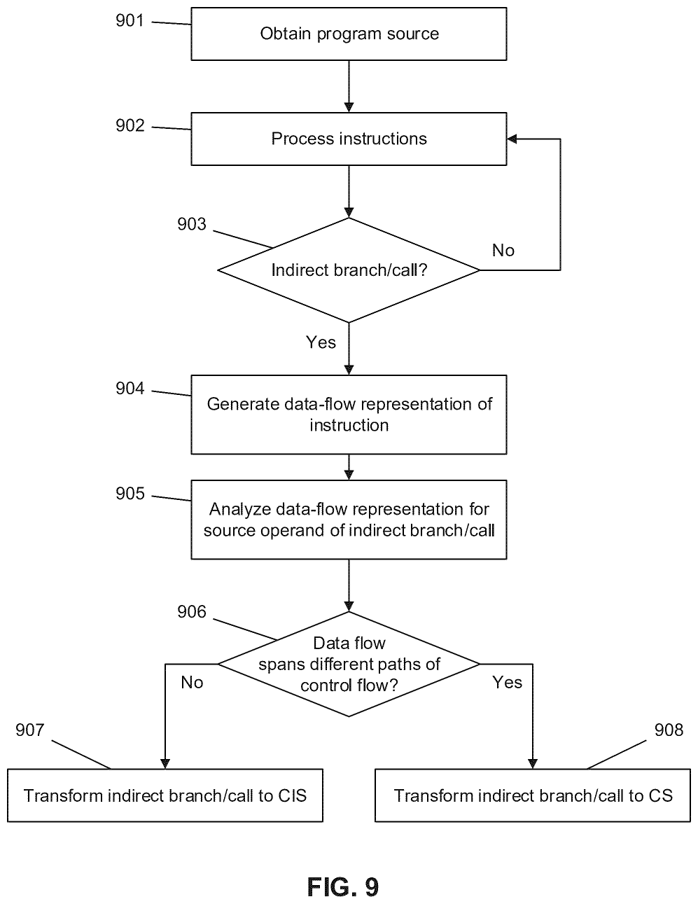

FIG. 9 shows a flowchart for a method for transforming indirect branches in accordance with an embodiment of the present disclosure. The method may be implemented, at least in part, by a program optimizer 501, as described in relation to FIG. 5. At action 901, a computer program (i.e., a first computer program) may be obtained from a program source 502. A sequence of instructions may define the computer program and may include one or more instructions each representing a respective indirect branch, namely an indirect branch instruction or an indirect call instruction. The computer program may, for example, be a program source code, a binary or executable code, or an intermediate form thereof. At action 902, the sequence of instructions may be processed sequentially. Each instruction may be evaluated, at action 903, to determine whether that instruction represents an indirect branch. When the instruction does not represent an indirect branch, the next instruction of the sequence of instructions may be processed, at action 902. When an instruction does represent an indirect branch, a data-flow representation, such as a data-flow graph, may be generated, at action 904, that identifies one or more preceding instructions of the sequence of instructions, each of which, when executed, determines the target of the indirect branch. This may include the preceding instructions affecting the target address stored in an operand of the indirect branch. In some embodiments where the data-flow representation is a data-flow graph, the data-flow graph may define dependencies of the indirect branch target on the one or more preceding instructions. At action 905, the data-flow representation may be analyzed to determine, at action 906, whether more than one preceding instruction, when executed, determines the target of the indirect branch. In other words, the analysis may determine whether address generation for the target address depends on different contexts. If only one preceding instruction determines the target or if the target of the indirect branch is independent of the preceding instructions, then the instruction corresponding to the indirect branch may be transformed, at action 907 to indicate CIS, such as by having an indicator identifying it as CIS. In some embodiments, if the analysis is unable to determine whether one or more preceding instructions determines the target of the indirect branch, the instruction corresponding to the indirect branch may also be transformed to indicate CIS. If one or more preceding instructions determines the target, then the instruction corresponding to the indirect branch may be transformed, at action 908, to indicate CS, such as by having an indicator identifying it as CS. The transformed instructions may be included in an optimized version of the computer program (i.e., a second computer program), as described in relation to the optimized program executable 503 of FIG. 5.

In some embodiments, when the data-flow representation is a data-flow graph, the graph may include a plurality of chains of instructions that are interdependent and affect the operand for the target of the indirect branch. Generating this data-flow graph may involve successively identifying preceding instructions starting from the indirect branch. Generation of the data-flow graph may terminate when, for example, a memory operation, such as a load operation, is found, or a memory function is found. Alternatively, generating the data-flow graph may be done interprocedurally, i.e., across function calls. Generation of the data-flow graph may terminate when a threshold for a number of instructions in the graph is reached. Termination conditions for graph generation may be selected to limit the temporal and spatial complexity of the graph in order to minimize demands from processing and storing the graph.

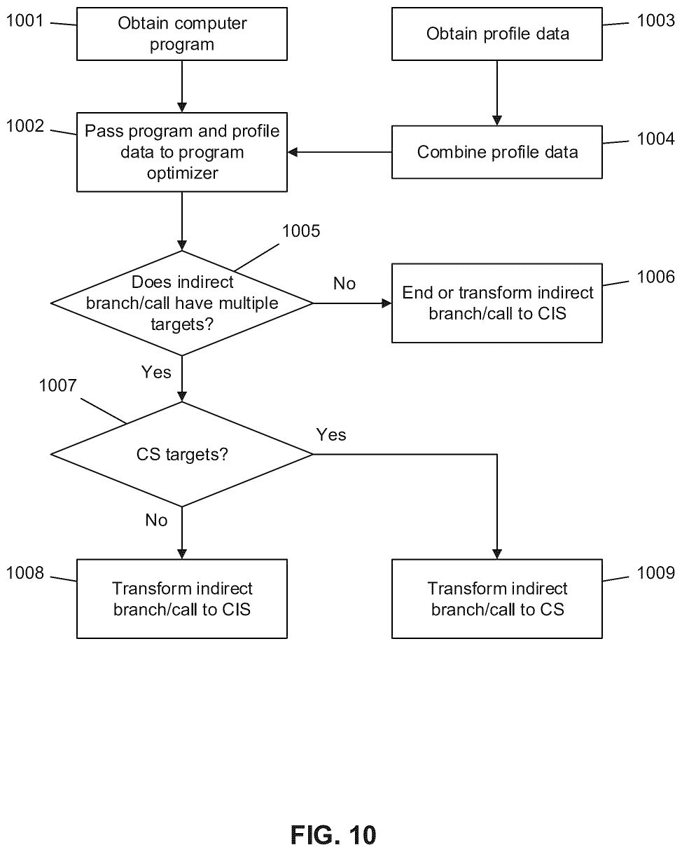

FIG. 10 shows a flowchart for a method for transforming indirect branches in accordance with another embodiment of the present disclosure. The method may be implemented, at least in part, by a program optimizer 501, as described in relation to FIG. 5. At action 1001, a computer program (i.e., a first computer program) may be obtained and, at action 1002, may be passed to the program optimizer 501. A sequence of instructions may define the computer program and may include one or more instructions each representing a respective indirect branch, namely an indirect branch instruction or an indirect call instruction. The computer program may, for example, be a program source code, a binary or executable code, or an intermediate form thereof. At action 1003, profile data 506 for the computer program may be obtained. A person skilled in the art will appreciate that the profile data 506 may be obtained through a variety of methods, which may include but may not be limited to sampling-based profiling or instrumentation-based profiling. The profile data 506 may be obtained from one or more previous executions of the computer program. At action 1004, when profile data from different executions of the computer program is obtained, the profile data 506 may be combined. At action 1002, the profile data 506 may be passed together with the computer program to the program optimizer 501. At action 1005, the program optimizer 501 may evaluate the computer program in accordance with the profile data 506 to identify indirect branches from among the sequence of instructions of the computer program and to determine whether each indirect branch has more than one targets. When an indirect branch has fewer than two targets, at action 1006, operations on the indirect branch may end or the indirect branch may be transformed to indicate CIS, such as by having an indicator identifying CIS. When an indirect branch has more than one target, at action 1007, the indirect branch may then be evaluated in accordance with the profile data 506 to determine whether at least one of the respective targets is CS. When none of the targets of the indirect branch is CS, at action 1008, the indirect branch may be transformed to indicate CIS, such as by having an indicator identifying CIS. When at least one target is CS, at action 1009, the indirect branch may be transformed to indicate CS, such as by having an indicator identifying CS. The transformed instructions may be included in an optimized version of the computer program (i.e., a second computer program), as described in relation to the optimized program executable 503 of FIG. 5.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

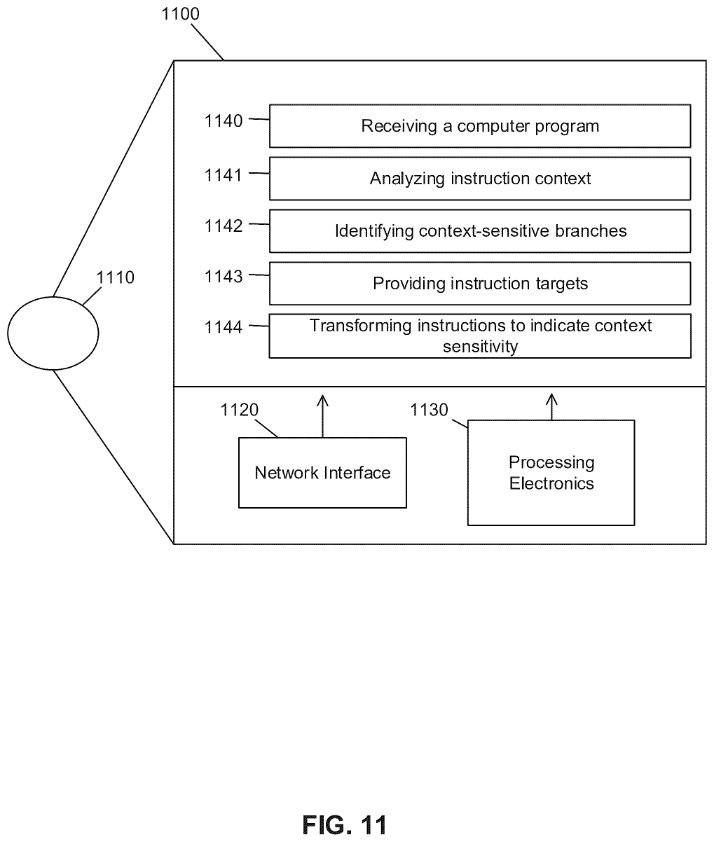

FIG. 11 shows an apparatus 1100 for indirect target prediction, according to embodiments of the present disclosure. The apparatus may be located at a node 1110 of a network. The apparatus may include a network interface 1120 and processing electronics 1130. The processing electronics 1130 may include a computer processor executing program instructions stored in memory, or other electronics components such as digital circuitry, including for example FPGAs and ASICs. The network interface 1120 may include an optical communication interface or radio communication interface, such as a transmitter and receiver. The apparatus may include several functional components, each of which may be partially or fully implemented using the underlying network interface 1120 and processing electronics 1130. Examples of functional components may include modules for receiving 1140 a computer program, analyzing 1141 instruction context, identifying 1142 context sensitive branches, providing 1143 instruction targets, and transforming 1144 instructions to indicate context sensitivity.

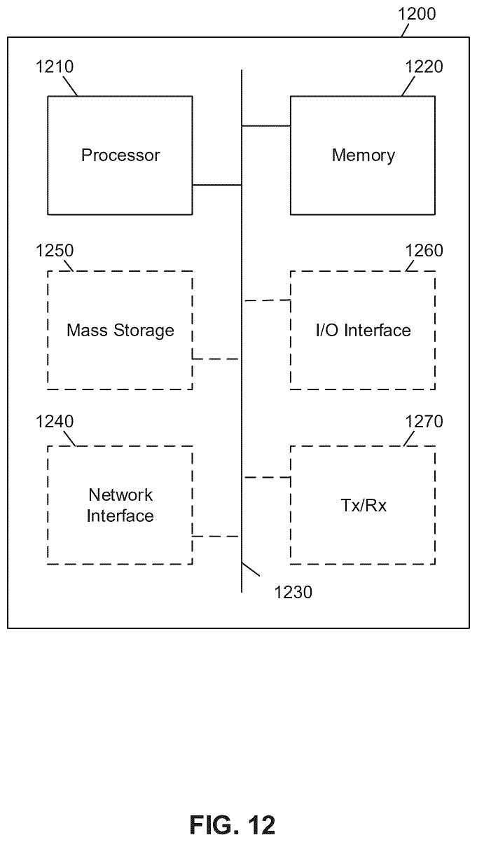

FIG. 12 shows a schematic diagram of an electronic device 1200 that may perform any or all of the operations of the above methods and features explicitly or implicitly described herein, according to different embodiments of the present disclosure. For example, a computer equipped with network function may be configured as electronic device 1200. The electronic device 1200 may be used to implement the program optimizer 501 or CPU 505 of FIG. 5, for example. The electronic device 700 may further be used as part of the ITP 700 of FIG. 7, including as part of the CIS-ITP 701 or the CS-ITP 702, for example.

As shown, the electronic device 1200 may include a processor 1210 (i.e., a processing unit), such as a CPU or specialized processors such as a Graphics Processing Unit (GPU) or other such processor unit, memory 1220, and a bi-directional bus 1230 to communicatively couple the components of electronic device 1200. Electronic device 1200 may also optionally include a network interface 1240, non-transitory mass storage 1250, an I/O interface 1260, and a transceiver 1270. According to certain embodiments, any or all of the depicted elements may be utilized, or only a subset of the elements. Further, the electronic device 1200 may contain multiple instances of certain elements, such as multiple processors, memories, or transceivers. Also, elements of the hardware device may be directly coupled to other elements without the bi-directional bus 1230. Additionally or alternatively to a processor and memory, other electronics, such as integrated circuits, may be employed for performing the required logical operations.

The memory 1220 may include any type of tangible, non-transitory memory such as static random access memory (SRAM), dynamic random access memory (DRAM), synchronous DRAM (SDRAM), read-only memory (ROM), any combination of such, or the like. The mass storage element 1250 may include any type of tangible, non-transitory storage device, such as a solid-state drive, hard disk drive, a magnetic disk drive, an optical disk drive, USB drive, or any computer program product configured to store data and machine executable program code. According to certain embodiments, the memory 1220 or mass storage 1250 may have recorded thereon statements and instructions executable by the processor 1210 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium such as a compact disk read-only memory (e.g. CD-ROM), USB flash disk, a removable hard disk, or the like. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising, at an electronic device including a first processing unit and a second processing unit each coupled to tangible, non-transitory processor-readable memory:
receiving, from a computer program, an instruction representing an indirect branch of the computer program, the instruction having an indicator identifying one of context-sensitive (CS) and context-insensitive (CIS);
providing, when at least one of a respective directory at each of the first processing unit and the second processing unit has a respective existing entry corresponding to the instruction, a target identifier of at least one respective existing entry, the target identifier identifying a target for the indirect branch;
and
generating, in the respective directory at the first processing unit when the instruction indicates CIS and in the respective directory at the second processing unit when the instruction indicates CS, a respective instant entry corresponding to the instruction when the respective directories at each of the first processing unit and the second processing unit do not have the respective existing entry corresponding to the instruction.

2. The method of claim 1 further comprising, at the electronic device:
determining, at the first processing unit when the instruction indicates CIS and at the second processing unit when the instruction indicates CIS, whether the respective directory has the respective existing entry corresponding to the instruction.

3. The method of claim 1 wherein the respective existing entry of the respective directory at the first processing unit is a tag including a hash of a program counter.

4. The method of claim 1 wherein the respective existing entry of the respective directory at the second processing unit is a tag including a hash of a program counter and context information.

5. The method of claim 4 wherein the context information includes at least one of a branch address, a branch taken and not-taken history, and a function call stack.

6. The method of claim 1 wherein generating, in the respective directory at the first processing unit when the instruction indicates CIS and in the respective directory at the second processing unit when the instruction indicates CS, the respective instant entry corresponding to the instruction when the respective directories at each of the first processing unit and the second processing unit does not have the respective existing entry corresponding to the instruction includes:
initiating a fill mechanism to complete the respective instant entry in accordance with the target for the indirect branch of the computer program.

7. The method of claim 1 wherein the indicator of the instruction is a label of one of CS and CIS.

8. The method of claim 1 wherein providing, when at least one of the respective directories at each of the first processing unit and the second processing unit has the respective existing entry corresponding to the instruction, the target identifier of at least one respective existing entry includes:
providing, when each of the respective directories at each of the first processing unit and the second processing unit has the respective existing entry corresponding to the instruction, the target identifier of one respective existing entry in accordance with an arbitration scheme.

9. An electronic device comprising a first processing unit and a second processing unit each coupled to non-transitory processor-readable memory, the memory having stored thereon instructions to be executed by the first processing unit and the second processing unit to implement a method comprising:
receiving, from a computer program, an instruction representing an indirect branch of the computer program, the instruction having an indicator identifying one of context-sensitive (CS) and context-insensitive (CIS);
providing, when at least one of a respective directory at each of the first processing unit and the second processing unit has a respective existing entry corresponding to the instruction, a target identifier of at least one respective existing entry, the target identifier identifying a target for the indirect branch of the computer program;
and
generating, in the respective directory at the first processing unit when the instruction indicates CIS and in the respective directory at the second processing unit when the instruction indicates CS, a respective instant entry corresponding to the instruction when the respective directories at each of the first processing unit and the second processing unit do not have the respective existing entry corresponding to the instruction.

10. A method comprising, at a processing unit coupled to tangible, non-transitory processor-readable memory:
receiving a sequence of instructions defining a first computer program, one or more instructions of the sequence of instructions each representing a respective indirect branch of the first computer program, each indirect branch having associated thereto a respective target;
executing, for each of the one or more instructions of the sequence of instructions, a set of actions including:
generating a respective data-flow representation identifying one or more respective preceding instructions of the sequence of instructions, each of the preceding instructions, when executed, determining the respective target of the respective indirect branch;
and
transforming, when more than one respective preceding instruction, when executed, determines the respective target of the respective indirect branch, the respective instruction to have an indicator identifying context-sensitive (CS);
and
providing a second computer program depending from the first computer program and including each of the transformed instructions.

11. The method of claim 10 wherein the set of actions further includes:
transforming, when the respective target of the respective indirect branch is independent from the one or more respective preceding instructions, the respective instruction to have an indicator identifying context-insensitive (CIS).

12. The method of claim 10 further comprising, at the processing unit:
evaluating each instruction of the sequence of instructions to determine whether the respective instruction generates values, for one or more subsequent instructions of the sequence of instructions, in the data-flow representation.

13. The method of claim 10 wherein the set of actions further includes:
analyzing the respective data-flow representation to determine whether more than one preceding instruction, when executed, determines the respective target of the respective indirect branch.

14. The method of claim 10 wherein the data-flow representation respective to each of the one or more instructions is a data-flow graph defining respective dependencies of the respective target on the one or more respective preceding instructions.

15. A method comprising, at a processing unit coupled to tangible, non-transitory processor-readable memory:
receiving a sequence of instructions defining a first computer program, one or more instructions of the sequence of instructions each representing a respective indirect branch of the first computer program, each indirect branch having associated thereto a respective one or more targets;
receiving profile data corresponding to at least one execution of the first computer program;
evaluating the first computer program in accordance with the profile data to identify the one or more instructions of the sequence of instructions;
transforming, for each of the one or more instructions of the sequence of instructions, when the respective indirect branch has more than one respective target and when at least one respective target is context-sensitive (CS), the respective instruction to have an indicator identifying CS;
and
providing a second computer program depending from the first computer program and including each of the transformed instructions.

16. The method of claim 15 further comprising, at the processing unit:
transforming, for each of the one or more instructions of the sequence of instructions, when the respective indirect branch has fewer than two respective targets, the respective instruction to have an indicator identifying context-insensitive (CIS).

17. The method of claim 15 further comprising, at the processing unit:
transforming, for each of the one or more instructions of the sequence of instructions, when the one or more respective targets of the respective indirect branch are context-insensitive, the respective instruction to have an indicator identifying context-insensitive (CIS).

18. The method of claim 15 further comprising, at the processing unit:
evaluating the first computer program in accordance with the profile data to determine, for each of the one or more instructions of the sequence of instructions, whether the respective indirect branch has more than one respective target.

19. The method of claim 15 further comprising, at the processing unit:
evaluating the first computer program in accordance with the profile data to determine, for each of the one or more instructions of the sequence of instructions, whether at least one respective target is CS.

20. The method of claim 15 wherein the profile data is a combination of a plurality of profiles each associated with a respective execution of the first computer program.
